(19) United States
(12) Patent Application Publication
(10) Pub. No.: US 2010/0123662 A1
(43) Pub. Date: May 20, 2010

(54) METHOD AND APPARATUS FOR PROVIDING A USER INTERFACE ON A MOBILE DEVICE

(75) Inventor: John Thomas Sadler, Wake Forest, NC (US)

Correspondence Address: SNYDER, CLARK, LESCH & CHUNG, LLP, 754 ELDEN STREET, SUITE 202, HERNDON, VA, 20170, US

(73) Assignee: SONY ERICSSON MOBILE COMMUNICATIONS AB, Lund (SE)

(21) Appl. No.: 12/271,384

(22) Filed: Nov. 14, 2008

(51) Int. Cl. G06F 3/02

(52) U.S. Cl. 345/169

(57) ABSTRACT

An approach provides for a user interface on a mobile device. A keystroke combination is detected between at least a modification key and a particular key of a keypad. An associated input is determined based on the step of detecting. The modification key is included on a first face of the mobile device and the keypad is included on a second face of the mobile device, the first face and the second face substantially face opposite directions.

### BACKGROUND

The present disclosure relates to mobile devices, more particularly to user interfaces for mobile devices.

Mobile devices, such as cellular phones, laptop computers, pagers, personal digital assistants (PDA), and the like, have become increasingly prevalent. These devices provide the convenience of handheld computing with increased functionality. For example, an expanding variety of features and applications have become available that, in addition to conventional voice and data communications, permit users to connect to a variety of information and media resources, such as the Internet, as well as enable users to send and receive short messages, engage in multimedia playback, exchange electronic mail, perform audio-video capturing, participate in interactive gaming, manipulate data, and engage in other like functions and applications. Still further, these functions and applications may, at times, be concurrently accessed or even toggled between.

Unfortunately, as the richness and complexity of these functions and applications increase, the complexity of the user interface has increased commensurately. For example, mobile devices are being developed with complete alphabet keypads, such as QWERTY keypads including at least twenty-six keys, to facilitate more involved applications that typically demand “faster” user inputs, such as instant messaging applications. At the same time, manufacturers are also creating smaller devices with decreasing surface area on which to locate convenient user interfaces. As such, it has become an ever-growing challenge for users to suitably and efficiently interact with these user interfaces. From an ergonomics standpoint alone, traditional keypads are becoming less and less capable to meet the demands of user interactivity, while at the same time enabling smaller and smaller mobile device form factors. Accordingly, convenient, easy to manipulate user interfaces that are at the same time compact, continue to be objectives for improvement.

Therefore, a need exists for improved mobile device user interfaces. There exists a particular need for mobile devices with improved keypad user interfaces.

### DISCLOSURE

The above described needs are fulfilled, at least in part, by detecting a keystroke combination between at least a modification key and a particular key of a keypad, and determining an associated input based on the step of detecting. The modification key is included on a first face of a mobile device and the keypad is included on a second face of the mobile device. The first face and the second face substantially face opposite directions.

A mobile device is provided including a processor, a first face including a modification key, and a second face including a keypad. The first face substantially faces a first direction, and the second face substantially faces a second direction substantially opposite from the first direction. The processor is configured to detect a keystroke combination between at least the modification key and a particular key of the keypad for determining an associated input.

Still other aspects, features, and advantages are readily apparent from the following detailed description, wherein a number of particular embodiments and implementations, including the best mode contemplated, are shown and described. The disclosure is capable of other and different embodiments, and its several details are capable of modifications in various obvious respects, all without departing from the spirit and scope of the disclosure. Accordingly, the drawings and description are to be regarded as illustrative in nature, and not as restrictive.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a key set design, according to an exemplary embodiment;

FIG. 2 is a diagram of a conventional QWERTY key set design;

FIGS. 3-5 are schematic diagrams of various perspective views of a mobile device including the key set design of FIG. 1, according to an exemplary embodiment;

FIG. 6 is a block diagram of the mobile device of FIGS. 3-5, according to an exemplary embodiment;

FIG. 7 is a flowchart of a process for detecting an input via the user interface of FIGS. 3-6, according to an exemplary embodiment;

FIGS. 8A-8D are schematic diagrams of displays configured to facilitate user interactivity with the user interface of FIGS. 3-5, according to exemplary embodiments; and

FIGS. 9A-9D are schematic diagrams of displays of an interactive game configured to acquaint users with the user interface of FIGS. 3-5, according to exemplary embodiments.

### DETAILED DESCRIPTION

An apparatus, method, and software for providing a user interface on a mobile device are disclosed. In the following description, for the purposes of explanation, numerous specific details are set forth in order to provide a thorough understanding of exemplary embodiments. It is apparent, however, to one skilled in the art that exemplary embodiments may be practiced without these specific details or with an equivalent arrangement. In other instances, well-known structures and devices are shown in block diagram form in order to avoid unnecessarily obscuring exemplary embodiments.

Although exemplary embodiments are described with respect to mobile devices and, in particular, to mobile communication devices, it is recognized that various exemplary embodiments have applicability to other devices and technologies. Furthermore, while specific reference is made to QWERTY-style keypad interfaces, it is contemplated that various exemplary embodiments are applicable to other keypad interface arrangements.

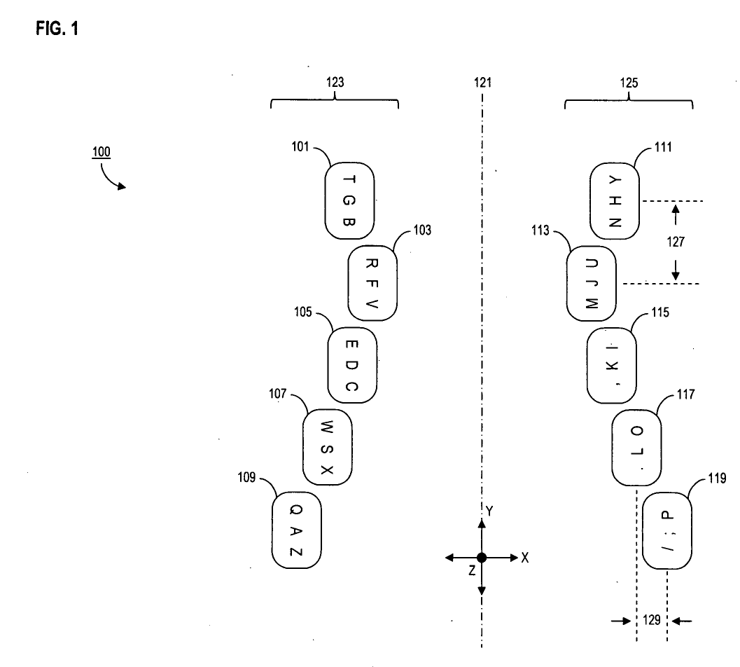

FIG. 1 is a schematic diagram of a key set design, according to an exemplary embodiment. In particular, key set 100 is arranged to provide one or more keys (e.g., keys 101, 103, 105, 107, 109, 111, 113, 115, 117, and 119) corresponding to one or more textual characters, which may be further associated with one or more other symbolic (or glyph) characters. These inputs will be generally referred to as character inputs. It is noted that keys 101-119 may additionally (or alternatively) serve other input functions, such as providing one or more directional inputs, graphical user interface selection abilities, menu traversal capabilities, and the like. While not illustrated, key set design 100 may also include one or more modification keys for dynamically modifying an input (e.g., character input) associated with a particular key of key set 100. For instance, a modification key may be utilized (e.g., actuated in concert with the particular key) to toggle between a plurality of inputs that may be associated with the particular key. According to certain embodiments, keys 101-119, as well as the modification key(s), may be physically manipulable structures (e.g., pressable buttons, deformable members, etc.) or may be logically interactive representations of such structures (e.g., virtually selectable buttons, “soft” interface components, etc.) provided on, for example, a touch-sensitive display interface. In this manner, interaction with a particular key of key set 100 (e.g., depression of the particular key in an imaginary “Z” direction) may cause actuation of a signal that may be detected and/or identified by one or more components of a host device (not shown) and, thereby, reduced to a corresponding input, such as a character input or any other suitable entry or input function. It is noted that any suitable means may be employed to detect actuation of keys 101-119, such as mechanically actuated electrical conductors, motion sensors, optical sensors, pressure sensors, etc.

Keys 101-119 of key set 100 may be arranged in any suitable manner, such as positioned in one or more arrays, matrices, or other suitable patterns. According to one embodiment, keys 101-119 are positioned in two, five key columns that are arranged about an imaginary reference line 121 extending in an imaginary “Y” direction. That is, keys 101-109 may be arranged in column 123, while keys 111-119 may be arranged in column 125. As shown, columns 123 and 125 are arcuately formed and respectively curve away from reference line 121 in substantially opposite directions, such as in opposite directions substantially extending in an imaginary “X” direction. In this manner, keys 103 and 113 may serve as respective apexes of the curves of columns 123 and 125, such that keys 103 and 113 may be dimensionally closest to reference line 121, while keys 109 and 119 may be dimensionally furthest from reference line 121. It is noted, however, that any one or more of keys 101-119 of columns 123 and 125 may serve as respective apexes of columns 123 and 125. According to particular implementations, the curves of columns 123 and 125 are configured to correspond to the outward curves formed by the tips of the fingers of an average user's left and right hands. In this manner, keys 101-119 may be positioned having a first dimensional pitch 127 extending in the imaginary “Y” direction, and a second dimensional pitch 129 extending in the imaginary “X” direction. Pitches 127 and 129 may be equal to or not equal to one another, and may be held constant or varied between respective keys 101-119 of key set 100, such as in the respective “Y” and/or “X” directions. While shown in the described manner, it is contemplated that columns 123 and/or 125 may be otherwise formed, such as formed in one or more linear arrangements, variable arrangements, or other geometric formations or other suitable patterns. Moreover, while columns 123 and 125 are shown symmetrically arranged about imaginary reference line 121, asymmetrical formations are also contemplated.

As previously mentioned, keys 101-119 of key set 100 may be associated with one or more inputs, such as one or more textual characters, symbolic characters, etc. In exemplary embodiments, character input associations for keys 101-119 may conform to a Roman script QWERTY-like key set arrangement; however, other suitable key set styles are contemplated, such as an AZERTY-style, DVORAK-style, QWERTZ-style, etc., as well as other suitable scripts, such as Arabic, Greek, Hebrew, Japanese, Latin, Russian, etc. Before describing the illustrated character input association for keys 101-119, the character input associations for a conventional QWERTY key set will be described.

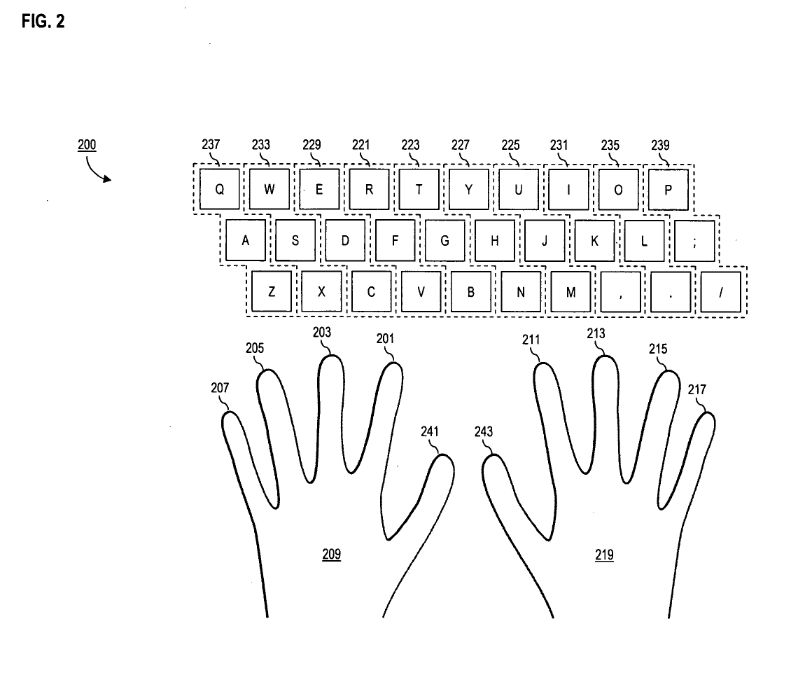

As seen in FIG. 2, there is illustrated a diagram of a conventional QWERTY key set 200. Key set 200 includes twenty-six keys corresponding to twenty-six textual characters, as well as four keys corresponding to four symbolic characters. It is noted that while conventional QWERTY key sets typically include additional keys, these keys have been left out for the sake of simplicity. As shown, the thirty keys are positioned according to a three by ten matrix, i.e., the keys are patterned in three rows and ten columns. In this manner, the name “QWERTY” is derived from the first six characters associated with the first six keys of the upper left-hand side of key set 200, i.e., keys “Q,” “W,” “E,” “R,” “T,” and “Y.”

As is well known, key set 200 can be utilized in a two-hand touch typing fashion, i.e., a typing method wherein a user utilizes their fingers and thumbs of their two-hands to strike (or otherwise actuate) the keys of key set 200 without having to use their sense of sight to find the keys. According to one common approach, two-hand touch typing typically entails a user placing their eight fingers of their left and right hands in a horizontal row along the middle (or “home”) row of keys of key set 200. More specially, fingers 201, 203, 205, and 207 of left hand 209 are respectively placed on the “F,” “D,” “S,” and “A” keys, while fingers 211, 213, 215, and 217 of right hand 219 are respectively placed on the “J,” “K,” “L,” and “Semi-Colon (;)” keys. As such, the “F,” “D,” “S,” and “A” keys can be considered “home” keys for fingers 201-207 of hand 209, while the “J,” “K,” “L,” and “Semi-Colon (;)” keys can be considered “home” keys for fingers 211-217 of hand 219. A user may easily strike these “home” keys without having to move their fingers about key set 200. The corollary is that to strike one of the remaining keys of key set 200, the user must first move one of their fingers to a desired key and then must correspondingly strike the desired key.

Consequently, the fingers of hands 209 and 219 may be utilized to strike (or otherwise actuate) certain groups of keys. For instance, finger 201 may be globally utilized to strike keys “R,” “F,” and “V” of key column 221, as well as keys “T,” “G,” and “B” of key column 223. Meanwhile, finger 211 may be globally utilized to strike keys “U,” “J,” and “M” of key column 225, as well as keys “Y,” “H,” and “N” of key column 227. Finger 203 may be globally utilized to strike keys “E,” “D,” and “C” of key column 229, while finger 213 may be globally utilized to strike keys “I,” “K,” and “Comma (,)” of key column 231. Still further, finger 205 may be globally utilized to strike keys “W,” “S,” and “X” of key column 233, while finger 215 may be globally utilized to strike keys “O,” “L,” and “Period (.)” of key column 235. As such, fingers 207 and 209 may be globally utilized to respectively strike keys “Q,” “A,” and “Z” of key column 237 and keys “P,” “Semi-Colon (;)” and “Slash (/)” of key column 239. While not illustrated, thumbs 241 and 243 are typically utilized to strike a spacebar. Utilizing key set 200 in conjunction with the aforementioned two-hand touch typing finger associations can enable users to efficiently input characters to a host device.

With this understanding of key set 200, the character input associations for keys 101-119 of key set 100 will now be described. According to exemplary embodiments, keys 101-119 have character input associations corresponding to one or more of the character input associations of key set 200. That is, fewer keys (e.g., ten keys) may be provided for via key set 100 than key set 200 for a same amount of associated character inputs, e.g., thirty character inputs. In this manner, however, the character input associations provided for via keys 101-119 may still preserve the relationship between keys and key columns described in connection with FIG. 2. Table 1 provides a mapping relationship between keys 101-119 of key set 100, associated input characters, and corresponding key column of key set 200.

TABLE 1

| KEY OF | ASSOCIATED | KEY COLUMN |
|---|---|---|
| KEY SET 100 | INPUT CHARACTERS | OF KEY SET 200 |
| 101 | T G B | 223 |
| 103 | R F V | 221 |
| 105 | E D C | 229 |
| 107 | W S X | 233 |
| 109 | Q A Z | 237 |
| 111 | Y H N | 227 |
| 113 | U J M | 225 |
| 115 | I K , | 231 |
| 117 | O L . | 235 |
| 119 | P ; / | 239 |

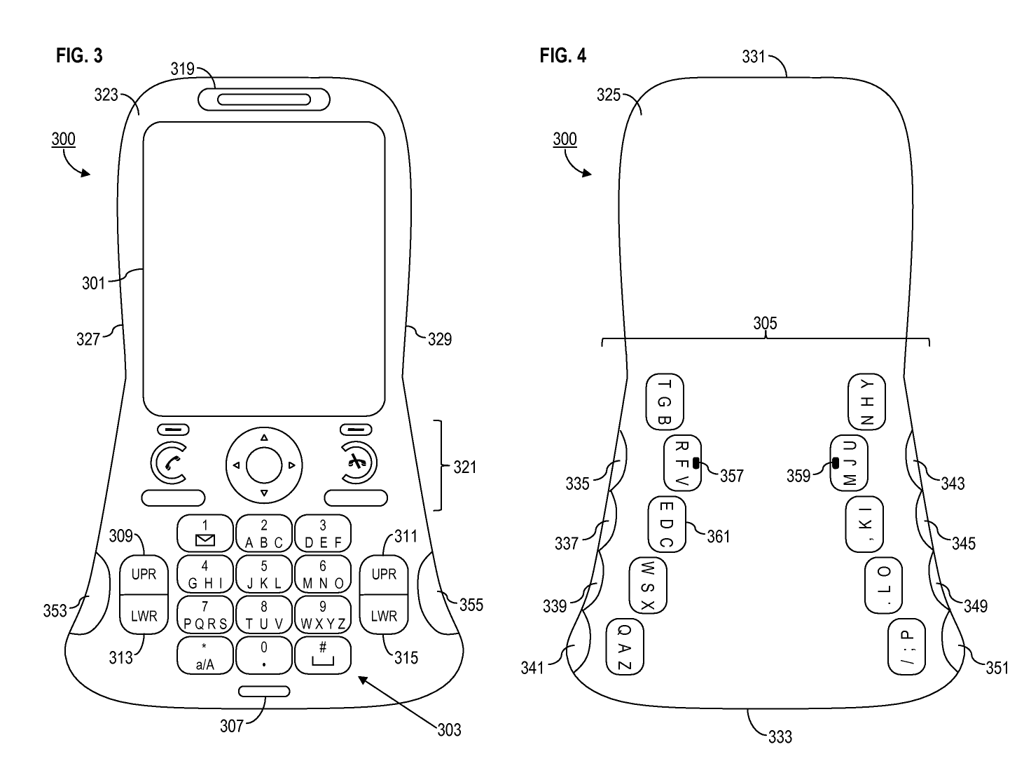

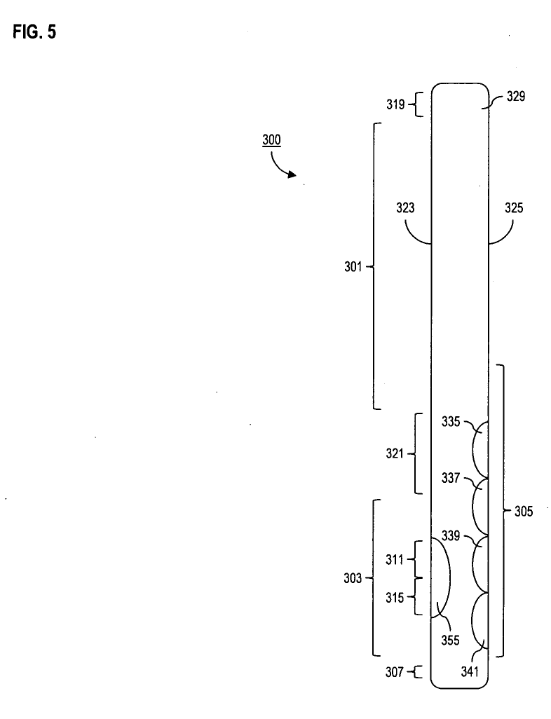

When key set 100 is implemented on a host device (such as illustrated in FIGS. 3-5), character input associations of key set 100 can also preserve the two-hand touch typing finger associations described in conjunction with FIG. 2. Table 2 provides an exemplary mapping relationship between keys 101-119 of key set 100, associated input characters, and associated fingers that may be utilized to actuate keys 101-119.

TABLE 2

| KEY OF | ASSOCIATED INPUT | ASSOCIATED |
|---|---|---|
| KEY SET 100 | CHARACTERS | FINGER |
| 101 | T G B | 201 |
| 103 | R F V | 201 |
| 105 | E D C | 203 |
| 107 | W S X | 205 |
| 109 | Q A Z | 207 |
| 111 | Y H N | 211 |
| 113 | U J M | 211 |
| 115 | I K , | 213 |
| 117 | O L . | 215 |
| 119 | P ; / | 217 |

Accordingly, when key set 100 is implemented on a host device, such as the mobile device of FIG. 3, key set 100 can be utilized to promote two-hand touch typing in a manner similar to that described in connection with key set 200 of FIG. 2. For example, key set 100 can be considered to include one or more “home” input keys associated with “default” input characters and one or more “other” input characters, as well as can be considered to include one or more “other” keys associated with “default” input characters and one or more “other” input characters. Like the “home” keys of key set 200, the “home” keys of key set 100 may be those keys that a user would initially place their eight fingers of their left and right hands on when engaging in two-hand touch typing on key set 200. According to one embodiment, keys 103-109 may be respectively classified as “home” keys for fingers 201-207 of hand 209, while keys 113-119 may be respectively classified as “home” keys for fingers 211-217 of hand 219. As such, the “default” input characters for these “home” keys of key set 100 can be made to correspond to the input characters a user may strike via key set 200 without having to move their fingers about key set 200. Namely, character inputs “F,” “D,” “S,” “A,” “J,” “K,” “L,” and “Semi-Colon (;)” may remain as “home” key character inputs for a user's left and right hands. In this manner, the “other” input characters for the “home” keys of key set 100 may correspond to the input characters of key set 200 that are included in a “same” key column as the “home” key of key set 200, i.e., those keys of a key column that a user must first move one of their fingers to before being able to strike a particular one of those keys. For example, the “home” input character for key 103 may be “F,” while the “other” input characters may be “R” and “V.” The “other” keys of key set 100 can relate to those keys of key set 200 that a user would have to move their fingers from a “home” key before being able to actuate one of these “other” keys. According to one embodiment, keys 101 and 111 may be respectively classified as “other” keys of key set 100 and may be associated with “default” input characters, as well as “other” input characters. For instance, the “default” input characters for keys 101 and 111 may be “G” and “H,” respectively. The “other” input characters for key 101 may be “T” and “B,” while the “other” input characters for key 111 may be “Y” and N.”

According to exemplary embodiments, the previously mentioned modification key(s) may be utilized to dynamically switch between “default” input characters associated with keys 101-119 of key set 100, and the “other” input characters associated with keys 101-119. In one particular implementation, key set 100 may include two modification keys that when actuated, for example, in combination with a particular key of key set 100 may dynamically modify an input associated with the particular key. For instance, if a first modification key is actuated in combination with a particular key of key set 100, then a first input character associated with the particular key may be input to the host device. This first input character may be considered a first modified input. In this way, if a second modification key is actuated in combination with the particular key of key set 100, then a second input character associated with the particular key may be input to the host device. This second input character may be considered a second modified input. If only the particular key is actuated, then a third input character associated with the particular key may be input to the host device. This third input character may be considered a default input character. Table 3 provides an exemplary mapping relationship between input characters associated with keys 101-119 of key set 100 and default and modified input cases.

TABLE 3

| | | FIRST | | SECOND |
|---|---|---|---|---|
| KEY OF | KEY | MODIFIED | DEFAULT | MODIFIED |
| KEY SET 100 | CLASS | INPUT | INPUT | INPUT |
| 101 | OTHER | T | G | B |
| 103 | HOME | R | F | V |
| 105 | HOME | E | D | C |
| 107 | HOME | W | S | X |
| 109 | HOME | Q | A | Z |
| 111 | OTHER | Y | H | N |
| 113 | HOME | U | J | M |
| 115 | HOME | I | K | , |
| 117 | HOME | O | L | . |
| 119 | HOME | P | ; | / |

As such, key set 100 can provide a more efficient and more compact user interface. For instance, a user need not move their fingers about key set 100 as much because a plurality of inputs may be associated with each individual key of key set 100. Moreover, these pluralities of input associations also enable key set 100 to provide a user interface that includes a less number of keys. Furthermore, when implemented on a host device, the aforementioned modification keys may be positioned so that a user can actuate them utilizing their thumbs, while keys 101-119 may be positioned so that the user can actuate keys 101-119 utilizing their fingers. When engaging in two-hand touch typing, a user's fingers are not required to move any more than necessary due, in part, to the fact that the user's thumbs, which are normally only utilized to actuate a spacebar, can be efficiently employed to ensure a desired input is dynamically associated with the particular key that is (or will be) actuated.

FIGS. 3-5 are schematic diagrams of various perspective views of a mobile device including the key set design of FIG. 1, according to an exemplary embodiment. In this example, mobile device 300 is illustrated and described in the context of a mobile communication device; however, it is contemplated that mobile device 300 may be configured as any variety of devices, such as a laptop computer, pager, personal digital assistant (PDA), radiophone, satellite phone, etc., as well as combinations thereof. According to exemplary embodiments, mobile device 300 includes a housing (or casing) that contains (or otherwise accommodates) one or more user interface components, such as display 301, keypad 303, keypad 305 implementing key set 100, microphone 307, modification keys 309, 311, 313, and 315, and speaker 319, as well as one or more other user controls 321, such as one or more buttons, dials, joysticks, etc. While not illustrated, the housing may also contain (or otherwise accommodate) one or more other components configured for the transmission and reception of communication signals, such as cellular or otherwise wireless communication signals. In this manner, the housing may be configured to protection all or some of these components from an ambient environment.

More specifically, the housing includes a first major face (e.g., a front side) 323 and a second major face (e.g., a back side) 325 bounded by one or more minor faces 327, 329, 331, and 333. Minor faces 327 and 329 may respectively relate to left and right sides of mobile device 300, while minor faces 331 and 333 may respectively relate to top and bottom sides of mobile device 300. It is noted that these directional references are merely exemplary as they are dependent upon a particular orientation and particular vantage point of mobile device 300. In certain embodiments, minor faces 327 and 329 can be contoured in such a manner as to provide an ergonomic “look and feel” for mobile device 300, such as to provide a comfortable “fit” when held by a user in one or more of their hands. This ergonomic “look and feel” may additionally promote user interactivity with and input efficiency to mobile device 300, as the “look and feel” may enable a user's fingers to be more naturally and comfortably placed upon one or more of the keys of keypad 305. The housing of mobile device 300 may also include one or more other ergonomic features, such as one or more finger rests (e.g., finger rests 315, 317, 319, 321, 323, 325, 327, 329) and/or one or more thumb rests (e.g., thumb rests 331 and 333). Rests 315-333 may also enable a user's fingers to be more naturally and comfortably placed upon one or more of the keys of keypad 305. Furthermore, rests 315-333 may provide more surface area upon which a user's fingers and thumbs may bias against when the user actuates the various keys of keypads 303 and 305, as well as modification keys 309-315 and user controls 321. While the housing is shown in a brick-like (or candy bar-like) fashion, any other suitable housing designs may be utilized, such as a fold (or clamshell) housing, slide housing, swivel housing, and/or the like.

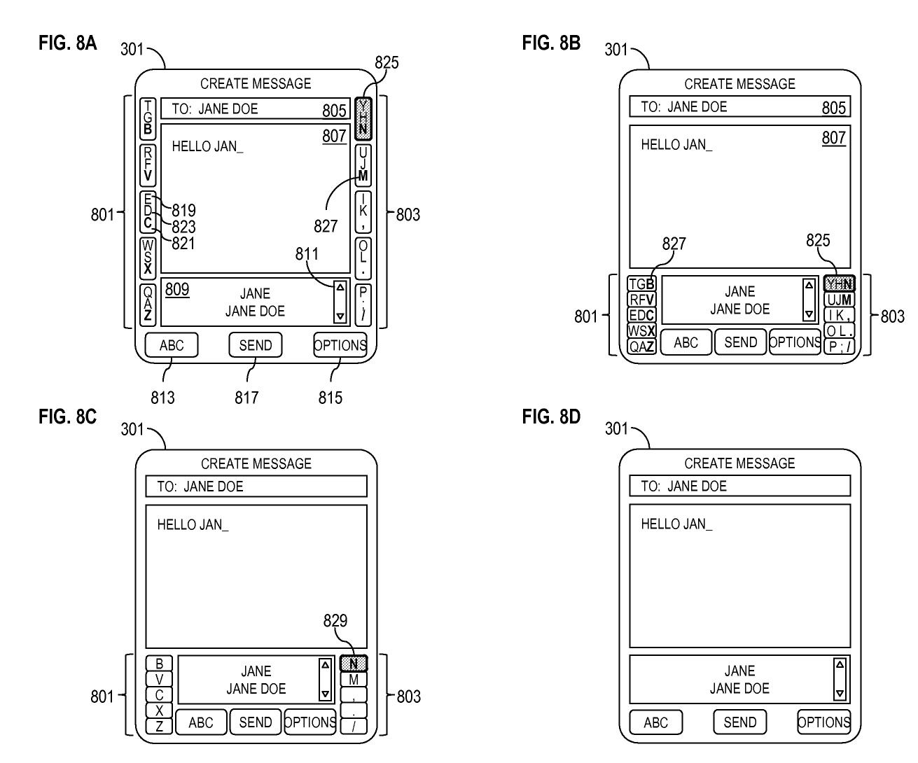

As seen in FIGS. 3-5, major face 323 includes display 301, which may be any suitable display, such as a light emitting diode (LED) display, liquid crystal display (LCD), plasma display, organic electro luminescence (OEL) display, etc, configured to present information to users. According to one embodiment, display 301 is adapted to present received information and, in some applications, transmit information input directly to display 301, to users of mobile device 300. Display 301 may also be touch or pressure sensitive and, thereby, may also act as an additional (or alternative) input interface to mobile device 300. In certain instances, display 301 may be utilized to facilitate user interactivity with keypad 305, as will be described in more detail in conjunction with FIGS. 8A-8D. Major face 323 may also include microphone 307 to accept audible signals from a user, speaker 319 to transmit audible signals to a user, and user controls 321 to provide another additional (or alternative) input interface to mobile device 300. It is noted that microphone 307 and speaker 319 may operate as parts of a voice (or speech) recognition input/output interface.

In exemplary embodiments, major face 323 includes modification keys 309-315 for dynamically modifying an input (e.g., character input) associated with a particular key of keypad 305, which may be provided for via major face 325. For instance, modification keys 309-315 may be utilized (e.g., actuated in concert with a particular key of keypad 305) to toggle between a plurality of character inputs that may be associated with a particular key of keypad 305. In one particular implementation, modification keys 309 and 311 may be utilized to dynamically modify character inputs associated with the keys of keypad 305 according to the “first modified inputs” of Table 3. Meanwhile, modification keys 313 and 315 may be utilized to dynamically modify character inputs associated with the keys of keypad 305 according to the “second modified inputs” of Table 3. As such, the keys of keypad 305 may have “default” character inputs according to the “default inputs” of Table 3.

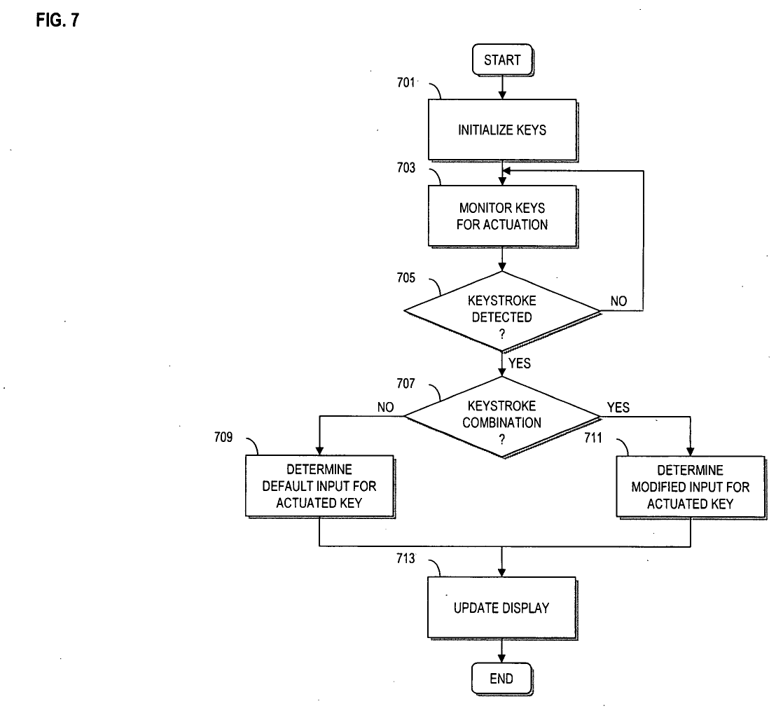

In one implementation, the positioning of modification keys 309-315 about major face 323 may relate to the manner in which modification keys 309-315 modify associated character inputs associated with the keys of keypad 305. More specifically, modification keys 309-315 may be positioned about major face 323 in such a manner that, when mobile device 300 is oriented and viewed as illustrated in FIG. 3, modification keys 309 and 311 are “above” modification keys 313 and 315. In a similar fashion, the character inputs associated with the keys of keypad 305 may be printed on (or otherwise presented by) the keys of keypad 305 in a similar “vertical” fashion. This “vertical” fashion may relate to a manner in which the character inputs are viewed on a conventional QWERTY key set, such as key set 200. For instance, key 361 of keypad 305 may be associated with three inputs, e.g., “E,” “D,” and “C,” which may be presented on key 361 with the “E” disposed “above” the “D,” and the “D” disposed “above” the “C,” when mobile device 300 is oriented and viewed as illustrated in FIG. 4. As seen in FIG. 2, key column 229 includes character inputs “E,” “D,” and “C,” with the “E” disposed “above” the “D,” and the “D” disposed “above” the “C.” Thus, keypad 305 may preserve a conventional spatial orientation for the character inputs associated with the various keys of keypad 305. Accordingly, modification keys 309 and 311 may be utilized to dynamically modify inputs associated with the keys of keypad 305 to the character inputs positioned “highest” on the respective keys of keypad 305. Meanwhile, modification keys 313 and 315 may be utilized to dynamically modify character inputs associated with the keys of keypad 305 to the character inputs positioned “lowest” on the respective keys of keypad 305. Thus, the “default” character inputs associated with the keys of keypad 305 may related to the character inputs positioned between the “highest” and “lowest” character inputs on the respective keys of keypad 305. It is noted that the “highest” character inputs may relate to the “first modified inputs” of Table 3, while the character “lowest” inputs may relate to the “second modified inputs” of Table 3. Such a configuration and application of keypad 305 and modification keys 309-315 facilitates user interactivity, as the character inputs and methods to obtain such character inputs are spatially similar to that of conventional key set 200. It is noted that an exemplary process for detecting user interaction with keypad 305 and modification keys 309-315 is more fully described in connection with FIG. 7.

To facilitate two-hand touch typing, modification keys 309-315 may be included on a first face (e.g., major face 323) of mobile device 300, while the keys of keypad 305 may be provided on a second face (e.g., major face 325) of mobile device 300. As major faces 323 and 325 substantially face in opposite directions, modification keys 309-315 and the keys of keypad 305 may substantially face in opposite directions. When mobile device 300 is held in a user's hands with display 301 substantially facing the user, modification keys 309-315 may be actuated via the user's thumbs, while the keys of keypad 305 may be actuated via the user's fingers. In this manner, the keys of keypad 305 and modification keys 309-315 can be utilized by a user to engage in two-hand touch typing, which may be further facilitated by one or more tactile identifiers (e.g., tactile identifiers 357 and 359). Tactile identifiers 357 and 359 may be utilized to locate certain keys of keypad 305. For instance, the aforementioned “home” keys of key set 100 may be more easily identified by a user through the user's sensory touch detection of tactile identifiers 357 and 359.

Contrastingly, keypad 303 may be a conventional keypad typically provided on telephony capable devices. Namely, keypad 303 may present numeric characters along with Roman script characters on a single interface, which may be configured for one-hand or two-hand thumb-typing. For example, keypad 303 may conform to one or more of the International Telecommunications Union (ITU) standards for the presentation of alphanumeric keys on devices having telephony capabilities. In the illustrated embodiment, keypad 303 is provided in accordance with ITU Standard E.161, entitled “Arrangement of Digits, Letters, and Symbols on Telephones and Other Devices that can be used for Gaining Access to a Telephone Network,” which is incorporated herein, by reference, in its entirety. This standard promulgates a ten or twelve key interface for presenting numeric characters “0” through “9” on a single keypad along with Roman script characters “A” through “Z.” In certain instances, other glyphs may be provided for, such as an asterisk (*), comma (,), number sign (#), period (.), semi-colon (;), slash (/), etc. As such, any individual key may be associated with one or more potential inputs, such that inputting a particular character may require certain keys to be actuated multiple times until a desired input is ultimately achieved. Actuation is typically performed via a user's thumbs. While useful in some instances, these keypad interfaces are becoming more and more unsuitable for applications demanding “faster” inputs, such as instant messaging, word processing, and other like text-based applications. Since keypad 305 and modification keys 309-315 can enable two-hand touch typing, keypad 305 and modification keys 309-315 can enhance user interactivity and increase user input efficiency to mobile device 300. It is contemplated that modification keys 309-315 may also be utilized to dynamically modify inputs (e.g., character inputs) associated with keys of keypad 303. In this manner, modification keys 309-315 may increase user interactivity and increase user input efficiency of keypad 303, as well. It is also noted that keypad 305 may be utilized in a similar manner as keypad 303, i.e., wherein individual keys may be associated with one or more potential inputs, such that inputting a particular character may require certain keys to be actuated multiple times until a desired character input is achieved.

Accordingly, when keypad 305 is provided on major face 325 (e.g., a typically under, if ever, utilized face), the available surface area of mobile device 300 may be more efficiently utilized. This may enable certain conventional components (e.g., display 301, keypad 303, etc.) to occupy more surface area of mobile device 300 than would otherwise be available. In other instances, the keys of keypad 305 may occupy more surface area than conventionally available to, for instance, conventional keypads, such as keypad 303. This can enable key dimensions and dimensional pitches between keys that are suitable for a convenient, easy to manipulate keypad interface. Also, mobile device 300 may be provided having a smaller overall form factor, as the available surface area of mobile device 300 may be more efficiently utilized.

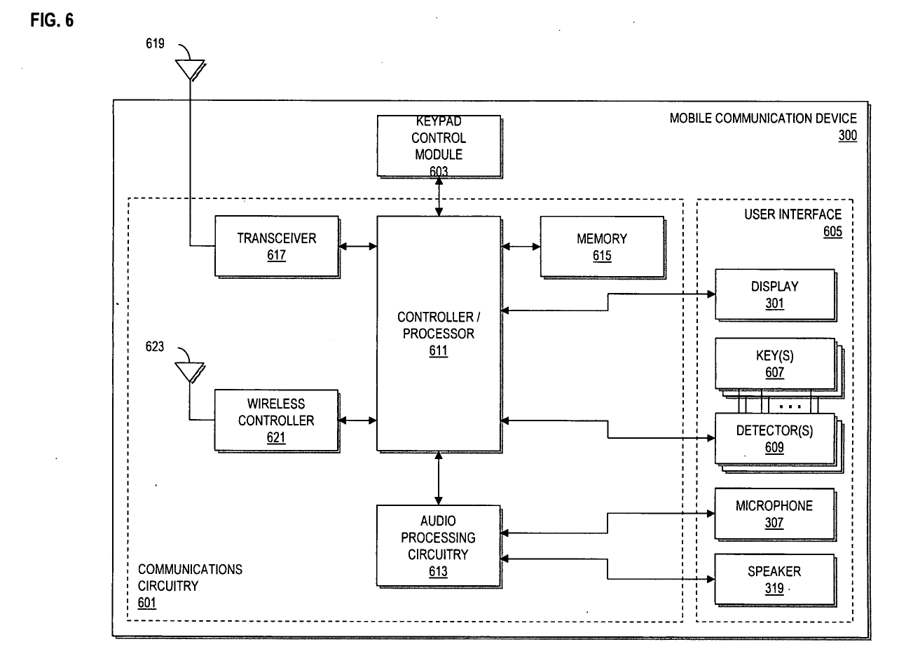

FIG. 6 is a block diagram of the mobile device of FIGS. 3-5, according to an exemplary embodiment. In this example, mobile device 300 is a mobile phone, such as a cellular radiophone; however, as previously mentioned, mobile device 300 may be configured as any variety of devices, such as a laptop computer, pager, personal digital assistant (PDA), satellite phone, etc., as well as combinations thereof. Accordingly, mobile device 300 may include communications circuitry 601, keypad control module 603, and user interface 605, as well as one or more other components to carry out the processes and functions described herein. While specific reference will be made thereto, it is contemplated that mobile device 300 may embody many forms and include multiple and/or alternative components.

User interface 601 includes one or more of the following: display 301, keys 607, microphone 307, and/or transducer (or speaker) 319. Display 301 provides a graphical interface that permits a user of mobile device 300 to view, for instance, call status, configurable features, contact information, dialed digits, directory addresses, menu options, operating states, time, and other information, such as character inputs to mobile device 300 via keys 607. The graphical interface may include icons and menus, as well as other text, soft controls, symbols, and/or widgets. In this manner, display 301 enables users to perceive and interact with the various features of mobile device 300.

Keys 607 may be included as one or more keypad interfaces. For instance, keys 607 may be provided as keypads 303 and 305, as well as modification keys 309-315. Thus, keys 607 may provide for a variety of user input operations. For example, keys 607 may include alphanumeric keys for permitting entry of alphanumeric information, such as configuration parameters, contact information, directory addresses, electronic mail messages, notes, phone lists, short text messages, word processing inputs, etc. In addition, keys 607 may represent other input controls, such as user controls 321, e.g., one or more button controls, dials, joysticks, and the like. Particular keys of a plurality of keys 607 may be utilized for different functions of mobile device 300, such as for conducting voice communications, short messaging, multimedia messaging, playing interactive games, etc. Keys 607 may include a “send” key for initiating or answering received communication sessions, and an “end” key for ending or terminating communication sessions. Special function keys may also include menu navigation keys, for example, for navigating through one or more menus presented via display 301, to select different mobile device functions, profiles, settings, etc. Other keys (e.g., modification keys 309-315) may be provided for dynamically modifying inputs (e.g., character inputs) associated with particular other keys, e.g., keys associated with keypads 303 and/or 305. Still further, certain key associated with mobile device 300 may include a volume key, an audio mute key, an on/off power key, a web browser launch key, etc. Keys or key-like functionality may also be embodied through one or more touch screens and associated soft controls presented via display(s) 301.

In this manner, actuation of keys 607 may be detected and/or identified by keypad control module 603 and/or detectors 607. For instance, keypad control module 603 may generate signals or commands for updating a presentation of display 301 or modifying a function of mobile device 300 in response to one or more signals provided by detectors 609 detecting actuation of one or more of keys 607. In particular, detectors 609 may be functionally interposed between keys 607 and controller (or processor) 611. Thus, keypad control module 603 and/or detectors 609 may convert “physical” actuation of one or more keys 607 into individual characters or other types of input for processing by controller 611. In cases of noncontact key technologies, keypad control module 603 and/or detectors 609, in the form of, for instance, firmware (possibly programmed into an application specific integrated circuit), may provide functional conversion between sensing “virtual” actuation of one or more of keys 607 and appropriate corresponding inputs. In this manner, keypad control module 603 may access one or more input mapping tables for generating associated inputs when one or more of keys 607 are actuated. These mapping tables may relate to the exemplary mapping relationships provided in Table 3. Inputs generated by keypad control module 603 may be communicated to controller 611 for executing applications requiring and/or expecting the entering of information via keys 607.

Microphone 307 converts spoken utterances of a user into electronic audio signals, while speaker 319 converts audio signals into audible sounds. Microphone 307 and speaker 319 may operate as parts of a voice (or speech) recognition system. Thus, a user, via user interface 605, can construct user profiles, enter commands, generate user-defined policies, initialize applications, input information (e.g., textual information), manipulate screen indicia (e.g., cursors), select options from various menu systems, and perform other like tasks and/or functions.

Communications circuitry 601 enables mobile device 300 to initiate, receive, process, and terminate various forms of communications, such as voice communications (e.g., phone calls), electronic mail messages, short message service (SMS) messages (e.g., text and picture messages), and multimedia message service (MMS) messages, etc. In other instances, communications circuitry 601 enables mobile device 300 to transmit, receive, and process voice signals and data, such as voice communications, endtones, image files, video files, audio files, ringbacks, ringtones, streaming audio, streaming video, video game information, etc. Communications circuitry 601 includes audio processing circuitry 613, controller (or processor) 611, memory 615, transceiver 617 coupled to antenna 619, and wireless controller 621 (e.g., a short range transceiver) coupled to antenna 623.

A specific design and implementation of communications circuitry 601 can be dependent upon one or more communication networks for which mobile device 300 is intended to operate. For example, mobile device 300 may be configured for operation within any suitable wireless network utilizing, for instance, an electromagnetic (e.g., radio frequency, optical, and infrared) and/or acoustic transfer medium. In various embodiments, mobile device 300 (i.e., communications circuitry 601) may be configured for operation within any of a variety of data and/or voice networks, such as advanced mobile phone service (AMPS) networks, code division multiple access (CDMA) networks, general packet radio service (GPRS) networks, global system for mobile communications (GSM) networks, internet protocol multimedia subsystem (IMT) networks, personal communications service (PCS) networks, time division multiple access (TDMA) networks, universal mobile telecommunications system (UTMS) networks, or a combination thereof. Other types of data and voice networks (both separate and integrated) are also contemplated, such as microwave access (MiMAX) networks, wireless fidelity (WiFi) networks, satellite networks, and the like.

Wireless controller 621 acts as a local wireless interface, such as an infrared transceiver and/or a radio frequency adaptor (e.g., Bluetooth adapter), for establishing communication with an accessory, hands-free adapter, another mobile communication device, computer, or other suitable device or network.

Processing communication sessions may include storing and retrieving data from memory 615, executing applications to allow user interaction with data, displaying video and/or image content associated with data, broadcasting audio sounds associated with data, and the like. Accordingly, memory 615 may represent a hierarchy of memory, which may include both random access memory (RAM) and read-only memory (ROM). Computer program instructions, such as application instructions for detecting and identifying inputs associated with actuated keys of keys 607, can be stored in non-volatile memory, such as erasable programmable read-only memory (EPROM), electrically erasable programmable read-only memory (EEPROM), and/or flash memory; however, may be stored in other types or forms of storage. Memory 615 may be implemented as one or more discrete devices, stacked devices, or integrated with controller (or processor) 611. Memory 615 may store program information, such as one or more user profiles, one or more user defined policies, one or more user interface control parameters, one or more mapping tables, etc. In addition, system software, specific device applications, program instructions, program information, or parts thereof, may be temporarily loaded to memory 615, such as to a volatile storage device, e.g., RAM. Communication signals received by mobile device 300 may also be stored to memory 615, such as to a volatile storage device.

Controller 611 controls operation of mobile device 300 according to programs and/or data stored to memory 615, as well as based on user input received through one or more of the components of user interface 605. Control functions may be implemented in a single controller (or processor) or via multiple controllers (or processors). Suitable controllers may include, for example, both general purpose and special purpose controllers, as well as digital signal processors, local oscillators, microprocessors, and the like. Controller 611 may also be implemented as a field programmable gate array (FPGA) controller, reduced instruction set computer (RISC) processor, etc. Controller 611 may interface with audio processing circuitry 613, which provides basic analog output signals to speaker 319 and receives analog audio inputs from microphone 307.

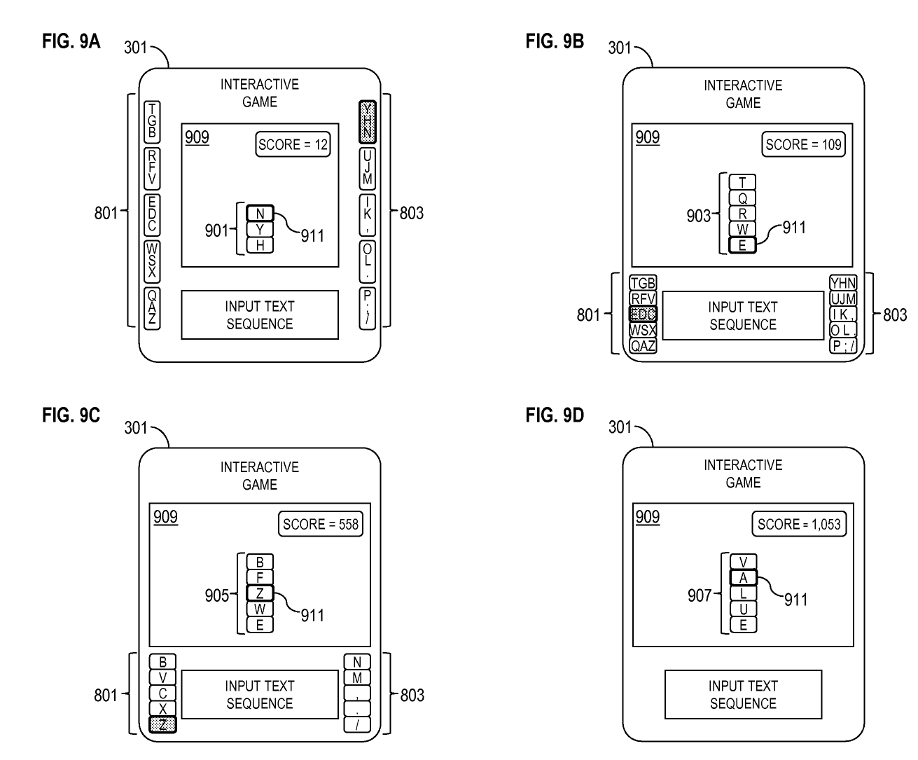

Controller 611, in addition to orchestrating various operating system functions, also enables execution of software applications, such as instant messaging applications, word processing application, etc., stored to memory 615. According to particular implementations, memory 615 may be utilized to store one or more interactive games configured to acquaint users with keypad 305 and modification keys 309-315. The interactive game may relate to a space invaders game incorporating text, Tetris with letters, and the like. One exemplary interactive game is explained in more detail in accordance with FIGS. 9A-9C. As such, a predetermined set of software applications that control basic device operations, such as voice and data communications, may be installed on mobile device 300 during manufacture, as well as computer instructions to implement exemplary embodiments described herein, such as the process of FIG. 7. It is contemplated that additional software modules may also be provided, such as a user interface module for controlling one or more components of user interface 605 or implementing input/output commands to and from the components of user interface 605. Other software modules may be provided for detecting or sensing actuation of keys 607.

While exemplary embodiments of mobile device 300 have been described with respect to a two-way radio frequency communication device having voice and data communication capabilities, embodiments of mobile device 300 are not so limited. For instance, mobile device 300 may additionally (or alternatively) correspond to any suitable wireless two-way communicator. For example, mobile device 300 can be a cellular phone, two-way trunked radio, combination cellular phone and personal digital assistant (PDA), smart phone, cordless phone, satellite phone, or any other suitable mobile communication device with voice and/or data communication capabilities, such as a mobile computing device.

FIG. 7 is a flowchart of a process for detecting an input via the user interface of FIGS. 3-6, according to an exemplary embodiment. More specifically, the process may be utilized by mobile device 300 to detect actuation of one or more of keys 607, e.g., one or more keystrokes associated with keypad 305 and/or modification keys 309-315. For illustrative purposes, the process is described with respect to detection of a keystroke, i.e., actuation of, a particular key (e.g., key 361) of keypad 305 and with respect to detection of a keystroke combination between a particular key (e.g., key 361) of keypad 305 and a modification key (e.g., modification key 309 or 313).

At step 701, keypad control module 603 initializes the keys of keypad 305 and modification keys 309-315. For example, keypad control module 603 may implement instructions stored to memory 615 in response to a user powering on mobile device 300. Powering on mobile device 300 may also cause controller 611 to provide, for instance, a graphical interface to a user via display 301. The graphical interface may include one or more input fields, menus, options, selections, etc., that enable users to input or otherwise interact with a function or application of mobile device 300. These fields, menus, options, selections, etc., can be populated, manipulated, or otherwise interacted with via user actuation one or more of the keys of keypad 305 (e.g., key 361) and/or modification keys 309-315 (e.g., modification key 309 or 313).

Accordingly, per step 703, mobile device 300 (e.g., keypad control module 603) monitors the keys of keypad 305 and modification keys 309-315 for user interaction. In certain embodiments, user actuation of the keys of keypad 305 and/or modification keys 309-315 may be monitored and, thereby, detected via one or more detectors 609, e.g., one or more mechanically actuated electrical conductors, motion sensors, optical sensors, pressure sensors, etc. As such, in step 705, keypad control module 603 determines whether one or more keystrokes to keypad 305 and/or modification keys 309-315 have been detected. Keypad control module 603 may determine whether a keystroke (or keystroke combination) has occurred, if one or more signals are provided to keypad control module 603 via detectors 609 relating to actuation of keypad 305 and/or modification keys 309-315. If no keystrokes are detected, then keypad control module 603 continues to monitor the keys of keypad 305 and modification keys 309-315.

If one or more keystrokes are detected, then keypad control module 603 determines, per step 707, whether a keystroke combination has been detected by, for example, detectors 609. If a keystroke combination is not detected, e.g., only key 361 is actuated, then keypad control module 603 may determine (at step 709) a default input associated with the actuated key. According to particular embodiments, this determination may be facilitated by reference to one or more mappings stored to, for instance, memory 615. As previously mentioned, these mappings provide tables correlating keystrokes and keystroke combinations to associated input characters. For example, keypad control module 603 may determine, based on these tables, that a default input associated with actuation of key 361 is character input “D.” If, however, a keystroke combination is detected, e.g., key 361 is actuated in concert with modification key 309 or 313, then keypad control module 603 may determine (per step 711) a modified input associated with the actuated keys. For instance, keypad control module 603 may determine, based on the mapping tables, that a modified input associated with actuation of key 361 in concert with modification key 309 may correspond to character input “E.” As another example, keypad control module 603 may determine, based on the mapping tables, that a modified input associated with actuation of key 361 in concert with modification key 313 may correspond to character input “C.” According to certain embodiments, if a modification key (e.g., modification key 309) is actuated before a key of keypad 305, keypad control module 603 may wait for a predetermined time period for a key of keypad 305 to be actuated before determining an associated character input. In this manner, modification keys 309-315 need not necessarily be actuated in direct concert with a particular key of keypad 305 for a user to input a keystroke combination. As such, a determined character input may be provided to controller 611 so that controller 611 may, per step 713, update a presentation of display 301, such as, for example, updating display 301 to present one of characters “E,” “D,” or “C” corresponding to the detected keystroke or keystroke combination.

FIGS. 8A-8D are schematic diagrams of displays configured to facilitate user interactivity with the user interface of FIGS. 3-5, according to exemplary embodiments. It is noted that since keypad 305 may be provided on a “backside” of mobile device 300 and may, therefore, not be readily visible to a user, it may be beneficial to provide the user with one or more visual indictors to facilitate interaction with keypad 305. These visual indicators may progressively adapt to a user's comfortable level with keypad 305 and may also be deactivated by the user when the user is comfortably acquainted with keypad 305. As seen in FIGS. 8A-8D, there is shown a progression of presenting one or more visual indicators (e.g., visual indicators 801 and 803) relating to keypad 305 via display 301. For the purposes of illustration, display 301 is shown providing a graphical interface to a user for creating a message, such as a text message. As such, display may provide one or more regions (e.g., regions 805 and 807) for inputting characters. Region 805 may relate to a “TO” field, for inputting a contact (e.g., JANE DOE) intended to receive a message that may be input to region 807. Region 809 may provide one or more textual disambiguation results based on one or more inputs to one or more of regions 805 and 807. These results may be scrolled through via navigation bar 811. One or more soft interface controls (e.g., controls 813-817) may be presented via display 301 for changing between upper and lower case inputs (e.g., control 813), selecting more or more options related to populating a message (e.g., control 815), and/or transmitting the message to the intended contact (e.g., control 817).

Referring to FIG. 8A, there is shown a first level of visual indicators 801 and 803 associated with keypad 805. Visual indicators 801 and 803 illustrate each of the keys of keypad 305, as well as each of the available inputs associated with each of the keys of keypad 305. Visual indicators 801 and 803 are oriented similarly to the orientation of the columns of keys of keypad 305, e.g., columns 123 and 125 of key set 100. Further, the inputs associated with each of the keys of keypad 305 are arranged “vertically.” For instance, the inputs associated with key 361 may include a first modified input 819 (e.g., “E”) provided “above” the other inputs (e.g., “D” and “C”) associated with key 361, while a second modified input 821 (e.g., “C”) may be provided “below” the other inputs (e.g., “E” and “D”) associated with key 361. Further, a default input 823 is provided between the first modified input 819 and the second modified input 821. A first fixed focus state 825, e.g., highlighting and bolding features to a particular visual indicator, may be provided to indicate a key presently (or lastly) actuated by a user. A second fixed focus state 827, e.g., bolding features to particular inputs of each visual indicator, may be provided to indicate whether or not a modification key has been actuated, as well as which modification key has been actuated. Namely, input 819 would be bolded if modification key 309 or 311 was actuated, while input 821 would be actuated if modification key 313 or 315 was actuated. If no modification key was actuated then input 823 would be bolded.

As the user grows more accustomed to and comfortable with keypad 305, visual indicators 801 and 803 may be provided as shown in FIG. 8B. Visual indicators 801 and 803 are provided in a similar orientation as the columns of keys of keypad 305, e.g., columns 123 and 125 of key set 100; however, the inputs associated with each of the keys are keypad 305 are arranged “horizontally.” This may enable a more compact version of visual indicators 801 and 803, as well as enable regions 805 and 807 to occupy more of display 301. In this embodiment, fixed focus states 825 and 827 are still provided. When the user becomes even more accustomed to and comfortable with keypad 305, visual indicators 801 and 803 may be provided as shown in FIG. 8C. Visual indicators 801 and 803 provided in a similar orientation as the columns of keys of keypad 305, e.g., column 123 and 125 of key set 100; however, only a “currently” associated input for each of the keys is presented by visual indicators 801 and 803. Namely, no modification key is actuated visual indicators would presented the default input associations for the keys of keypad 305. Accordingly, if a modification key is actuated, then visual indicators 801 and 803 would presented corresponding modified input associations for the keys of keypad 305. As shown, either modification key 313 or 315 is actuated. In this embodiment, fixed focus states 825 and 827 are combined into fixed focus state 829, e.g., highlighting and bolding features to a particular visual indicator, to indicate a key presently (or lastly) actuated by a user. Thus, when a user becomes fully acquainted with keypad 305, visual indicators 801 and 803 may be eliminated from display 301, as seen in FIG. 8D.

FIGS. 9A-9D are schematic diagrams of displays of an interactive game configured to acquaint users with the user interface of FIGS. 3-5, according to exemplary embodiments. It is noted that since keypad 305 may be provided on a “backside” of mobile device 300 and may, therefore, not be readily visible to users, it may be beneficial to provide an interactive game on mobile device 300 to acquaint users with the use of keypad 305 and modification keys 309-315. While any interactive character based game may be utilized, the illustrated interactive game of FIGS. 9A-9D entails users inputting character sequences presented via display 301, such as character sequences 901, 903, 905, and 907 presented via display 301 of gaming region 909. In this manner, as fixed focus state 911 progresses through a particular character sequence, such as character sequence 901, a user would be required to input a corresponding character via keypad 305 and, in certain instances, via one of modification keys 309-315, as well.

According to exemplary embodiments, as a user becomes acquainted with keypad 305 and modification keys 309-315, the character sequences of the interactive game may require greater skill and finger dexterity from users. For instance, as seen in FIG. 9A, character sequence 901 may require a first skill level. That is, a user may only be required to manipulate a single key of keypad 305 and, in certain instances, modification keys 309-315. At a second skill level, character sequence 903 of FIG. 9B may require users to manipulate all the keys of a particular hand and, in certain instances, a modification key of particular type (e.g., modification key 309). As the user's skill grows further, a third skill level can be required, such as by character sequence 905. Character sequence 905 may require users to manipulate the keys of particular hand and, in certain instances, more than one type of modification key (e.g., modification keys 309 and 313). At a fourth skill level, character sequence 907 may require users to manipulate various keys of keypad 305 with fingers of both of their hands, as well as to manipulate various modification keys 309-315 with thumbs of both of their hands. As previously described in conjunction with FIGS. 8A-8D, one or more visual indicators (e.g., visual indicators 801 and 803) may be dynamically provided for via the illustrated interactive game of FIGS. 9A-9D. In this way, as a user's skill and comfort level increase, less information may be provided for via visual indicators 801 and 803. As such, a user can become fully acquainted with two-hand touch typing via keypad 305 and modification keys 309-315 by interacting with the interactive game of FIGS. 9A-9D.

While the disclosure has been described in connection with a number of embodiments and implementations, the disclosure is not so limited, but covers various obvious modifications and equivalent arrangements, which fall within the purview of the appended claims. Although features of the disclosure are expressed in certain combinations among the claims, it is contemplated that these features can be arranged in any combination and order.

What is claimed is:

1. A method comprising:
detecting a keystroke combination comprising a modification key and a particular key of a keypad; and
determining an associated input based on the step of detecting,
wherein the modification key is included on a first face of a mobile device and the keypad is included on a second face of the mobile device, the first face and the second face substantially facing opposite directions.

2. A method as recited in claim 1, further comprising:
displaying the associated input in a direction that substantially faces the same direction as the function key.

3. A method as recited in claim 1, wherein the first face includes another keypad.

4. A method as recited in claim 1, wherein the keypad is a QWERTY keypad.

5. A method as recited in claim 1, wherein the keypad includes ten keys divided into two columns of five keys.

6. A method as recited in claim 5, wherein the columns are arcuately arranged and curve in substantially opposite directions.

7. A method as recited in claim 1, further comprising:
executing an interactive game configured to acquaint a user with the keypad.

8. A method as recited in claim 1, wherein the particular key includes a tactile identifier.

9. A method recited in claim 1, wherein the first face further includes a first rest for resting a thumb and the second face includes a second rest for resting a finger.

10. A method as recited in claim 1, wherein the mobile device is configured for wireless communications.

11. An apparatus comprising:
a processor;
a first face including a modification key, the first face substantially facing a first direction; and
a second face including a keypad, the second face facing a second direction substantially opposite from the first direction,
wherein the processor is configured to detect a keystroke combination comprising the modification key and a particular key of the keypad for determining an associated input.

12. An apparatus as recited in claim 11, further comprising:
a display for displaying the associated input,
wherein the display substantially faces the first direction.

13. An apparatus as recited in claim 11, wherein the first face includes another keypad.

14. An apparatus as recited in claim 11, wherein the keypad is a QWERTY keypad.

15. An apparatus as recited in claim 11, wherein the keypad includes ten keys divided into two columns of five keys.

16. An apparatus as recited in claim 15, wherein the columns are arcuately arranged and curve in substantially opposite directions.

17. An apparatus as recited in claim 11, further comprising:
a memory,
wherein the memory stores data representing an interactive game configured to acquaint a user with the keypad.

18. An apparatus as recited in claim 11, wherein the particular key includes a tactile identifier.

19. An apparatus as recited in claim 11, wherein the first face further includes a first rest for resting a thumb and the second face includes a second rest for resting a finger.

20. An apparatus as recited in claim 11, further comprising:
a communication interface for engaging in wireless communications.
